(19) United States
(12) Patent Application Publication
(10) Pub. No.: US 2025/0298973 A1
(43) Pub. Date: Sep. 25, 2025

(54) Methods and Systems for Inserting Insights Derived Using Natural Language into Customer Relationship Management Systems

(71) Applicant: Winn.ai Labs LTD., Ramat Gan (IL)

(72) Inventors: Bar Haleva, Herzliya (IL); Orr Mendelson, Netzer Sereni (IL)

(21) Appl. No.: 18/611,910

(22) Filed: Mar. 21, 2024

(51) Int. Cl. G06F 40/205; G06F 16/35; G06Q 30/015

(52) U.S. Cl. CPC G06F 40/205; G06F 16/35; G06Q 30/015

(57) ABSTRACT

Computerized methods and systems analyze, using one or more natural language processing algorithms, at least one source of data that is representative of an interaction between a first party and a second party to extract from the at least one source of data, information that is descriptive of at least part of the interaction. The computerized methods and systems upload information derived from the extracted information to a data management system that manages data associated with the first party.

### TECHNICAL FIELD

The present disclosure relates to Natural Language Processing (NLP), and in particular uploading data, derived from interactions between customers and customer service representatives using NLP algorithm(s), to Customer Relationship Management (CRM) system(s).

### BACKGROUND OF THE INVENTION

Customer Relationship Management (CRM) systems are used to manage the interactions between representatives of an organization (typically sales or marketing persons), and customers (existing, past, or future customers) of the organization.

CRM systems typically include multiple data fields, which are typically filled by the representatives of an organization while engaging (interacting with) customers. The data fields of the CRM system are typically filled with the information that relates to the business of the organization, which is collected, searched, or learned from several sources, including customer meeting or discussion sessions (i.e., “conversations”).

In conventional approaches, filling of an organization's CRM system data fields is usually performed by representatives of the organization, and is usually performed after the conversation ends. Hence, there is no guarantee that the CRM filling will be performed within a certain time limit from the end of a conversation, or even be performed at all. The time gap between the end of a conversation and the CRM filling tends to cause a loss of information due to the person filling the CRM system (i.e., the representative of an organization) forgetting certain parts of the conversation and/or not placing emphasis on parts of the conversation that might be important to create value in the transaction between the parties (e.g., between the representative and the customer, between the organization and the customer, etc.).

Naturally, the less time that passes between the end of a conversation and the documenting of that conversation, and the more information is available and visible to the uploader, the less information is lost, and the more trustable the data in the CRM becomes.

### SUMMARY OF THE INVENTION

The present disclosed subject matter, also referred to herein as the disclosure, includes methods and systems that utilize one or more NLP algorithm(s) to enable the automatic (or semi-automatic) analysis of interactions between the representatives and customers. The analysis can be performed in real-time or offline using automated means. In certain embodiments, the methods and systems according to the present disclosure provide extraction of information from the interaction, classification of that information, arrangement or summary of the information, and placement of the information in forms or fields which can be selected manually or automatically. In certain embodiments, the methods and systems according to the present disclosure process parts of a conversation or timestamps in a conversation marked by a user (representative of an organization) as items of interest, whether classified by the user into categories or not classified into categories. In certain embodiments, the processing parts of the conversation includes one or more of presenting only the relevant part(s) of the conversation, classification of parts of the conversation, information extraction and arrangement, and insight generation based on the information. In certain embodiments, the information can then be presented to the representative for editing, approval, and insight extraction, prior to uploading of the information to the CRM system.

Embodiments of the present invention are directed to a method that enables the automatic (or semi-automatic) analysis of interactions between two parties. The method comprises: analyzing, using one or more natural language processing algorithms, at least one source of data that is representative of an interaction between a first party and a second party to extract from the at least one source of data, information that is descriptive of at least part of the interaction; and uploading information derived from the extracted information to a data management system that manages data associated with the first party.

Optionally, the at least one source of data includes at least one of linguistic data or textual data.

Optionally, the at least one source of data is a transcript of at least part of the interaction.

Optionally, the analyzing the at least one source of data includes transcribing the at least one source of data into text to produce a transcript of at least part of the interaction.

Optionally, the analyzing the at least one source of data further includes parsing the transcript into one or more transcript sections.

Optionally, the analyzing the at least one source of data further includes classifying the one or more transcript sections according to a plurality of classification labels.

Optionally, the at least one source of data is received from a computer memory.

Optionally, the information derived from the extracted information includes at least one insight of the interaction.

Optionally, the method further comprises: modifying, by the second party, the extracted information to produce the information derived from the extracted information, prior to the information derived from the extracted information being uploaded to the system.

Embodiments of the present invention are directed to a method that enables the automatic (or semi-automatic) analysis of interactions between two parties. The method comprises: analyzing, using one or more natural language processing algorithms, at least one source of data that is representative of an interaction between a customer and a customer service representative to extract from the at least one source of data insight data that is descriptive of at least one insight of the interaction; and uploading the insight data to a customer relationship management system that manages data associated with the customer and that is managed by an organization that includes the customer service representative.

Optionally, the at least one source of data includes at least one of linguistic data or textual data.

Optionally, the at least one source of data is a transcript of the interaction.

Optionally, the analyzing the at least one source of data includes transcribing the at least one source of data into text.

Optionally, each insight of the at least one insight is an insight in a category from a set of predetermined categories.

Optionally, the set of predetermined categories includes: questions and answers on topics in predefined conversation points of interest of the interaction, and indications that questions or answers were provided by the customer or the customer service representative.

Optionally, the method further comprises: modifying, by the customer service representative, the insight data prior to the insight data being uploaded to the customer relationship management system.

Optionally, the at least one source of data includes a plurality of sources of data, each source of data corresponding to a different respective aspect of the interaction, and the insight data includes a plurality of sets of data elements, each set of data elements being descriptive of a respective insight of a plurality of insights, each insight of the plurality of insights being associated with a different respective one of the aspects, the method further comprising: aggregating the data elements to produce an aggregated data element that is a representation of an aggregation of the plurality of insights.

Embodiments of the present invention are directed to a method that enables the automatic (or semi-automatic) analysis of interactions between two parties. The method comprises: analyzing, using one or more natural language processing algorithms, at least one source of data that is representative of an interaction between a customer of an organization and a customer service representative that is a member of the organization to extract from the at least one source of data information that is descriptive of at least part of the interaction; and uploading information derived from the extracted information to a customer relationship management system that manages data associated with the customer and that is managed by the organization.

As will become apparent from the following detailed description, the methods and systems according to embodiments of the present disclosure provide various advantages over conventional CRM solutions. One key advantage is the potential dramatic decrease in the amount of time until the CRM is filled, as well as the capture and arrangement of information and insights delivered in a conversation that are left out and forgotten by human CRM fillers. Accordingly, the methods and systems according to the present disclosure provide an increase in the quantity, quality, and accuracy of the information fed/uploaded to CRM systems.

Unless otherwise defined herein, all technical and/or scientific terms used herein have the same meaning as commonly understood by one of ordinary skill in the art to which the disclosure pertains. Although methods and materials similar or equivalent to those described herein may be used in the practice or testing of embodiments of the disclosure, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the present disclosure are herein described, by way of example only, with reference to the accompanying drawings. With specific reference to the drawings in detail, it is stressed that the particulars shown are by way of example and for purposes of illustrative discussion of embodiments of the disclosure. In this regard, the description taken with the drawings makes apparent to those skilled in the art how embodiments of the disclosure may be practiced.

Attention is now directed to the drawings, where like reference numerals or characters indicate corresponding or like components. In the drawings:

FIG. 1 is a diagram of an architecture of an exemplary system for inserting NLP insights into a CRM system, according to embodiments of the present disclosure;

FIG. 2 is a diagram illustrating an example environment in which a system for inserting NLP insights into a CRM system according to an embodiment of the present disclosure can be deployed;

FIG. 3 is a flow diagram illustrating a process for inserting NLP insights into a CRM system, according to an embodiment of the present disclosure;

FIG. 4 is a flow diagram illustrating a process for inserting NLP insights into a CRM system, according to another embodiment of the present disclosure;

FIG. 5 is a flow diagram illustrating a process for inserting NLP insights into a CRM system, according to yet another embodiment of the present disclosure; and

FIG. 6 is a flow diagram illustrating a process for inserting NLP insights into a CRM system, according to a further embodiment of the present disclosure.

### DESCRIPTION OF THE PREFERRED EMBODIMENTS

Embodiments of the present disclosure provide methods and systems for automatically or semi-automatically inserting information, including NLP insights, extracted by executing NLP algorithm(s) on interactions between two parties, into data management systems that are managed by organizations to which one of the two parties belongs.

The principles and operation of the methods and systems according to the present disclosure may be better understood with reference to the drawings accompanying the description.

Before explaining at least one embodiment of the disclosure in detail, it is to be understood that the disclosure is not necessarily limited in its application to the details of construction and the arrangement of the components and/or methods set forth in the following description and/or illustrated in the drawings and/or the examples. The disclosure is capable of other embodiments or of being practiced or carried out in various ways.

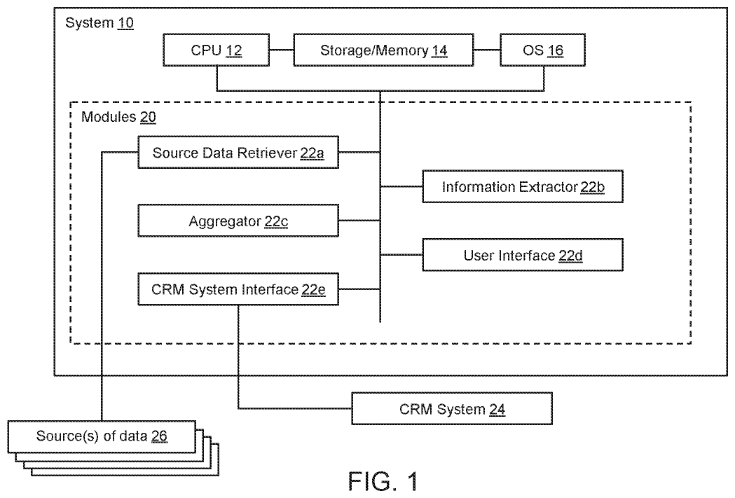

Referring now to the drawings, FIG. 1 illustrates an exemplary system 10 according to embodiments of the present disclosure as an architecture. The System 10 can be deployed locally on a customer/provider computing site and/or on a private cloud and/or on cloud services solutions, such as AWS provided by Amazon, GCP provided by Google (Alphabet), etc. The system 10 provides logic and logic functions, and is generally configured to extract information from interactions between two parties (a first party being a “customer” of an “organization” and a second party being a “customer service representative” that is a member of the organization) by performing natural language processing using one or more NLP algorithms, and to insert the extracted information into a data management system (CRM system) that is managed by the organization. The organization can be any type of business or other type of organization that has customers or clients. Examples of types of organizations include, but are not limited to, manufacturers, professional service firms, business-to-business (B2B) companies, and the like.

The system 10 includes a central processing unit (CPU) 12 formed from one or more processors, including hardware processors, and performs the processes (methods) of the present disclosure, such as those shown in the flow diagrams of FIGS. 3-6, and detailed below. These processes of FIGS. 3-6 may be in the form of programs, algorithms, and the like. The processors of the CPU 12 can, for example, be conventional processors, such as those used in servers, computers, and other computerized devices. For example, the processors may include x86 Processors from AMD and Intel, Xeon® and Pentium® processors from Intel, as well as any combinations thereof. In other embodiments, the processors can be special-purpose or application-specific processors.

The CPU 12 is electronically coupled (connected) to a storage/memory 14 for storing machine executable instructions, executable by the CPU 12, for performing the processes of the present disclosure, such as those shown in the flow diagrams of FIGS. 3-6, as will be detailed in subsequent sections of this document. The CPU 12 and the storage/memory 14, although each shown as a single component for representative purposes, may each be multiple components. The CPU 12 is also electronically coupled (connected), either directly or indirectly, to various modules 20 (computer components) that are configured to perform the various logic functions of the present disclosure. The CPU 12 is further electronically coupled (connected) to an operating system (OS) 16 that may load machine executable instructions, stored in the storage/memory 14, for execution by the CPU 12. The OS 16 may include any of the conventional computer operating systems, such as those available from Microsoft of Redmond Washington, commercially available as Windows® OS, such as Windows® 10, Windows® 7, MAC OS from Apple of Cupertino, CA, or Linux, or may include real-time operating systems, or may include any other type of operating system typically deployed in computer systems as known in the art.

The aforementioned modules 20 (computer components) are part of, or communicatively coupled to, the system 10, and are configured to perform the various logic functions of the disclosed embodiments. Typically, the system 10 includes software, software routines, computer program code, computer program code segments and the like, embodied, for example, in modules, computer components, and the like (exemplarily illustrated as computer modules 20). The computer modules 20, as computer components, are stored in a non-transitory computer readable storage medium, which is preferably one of the components of the storage/memory 14 or another non-transitory computer readable storage medium electronically coupled to the CPU 12, such that the machine executable instructions stored in the computer modules 20 can be loaded and executed by the CPU 12.

The CPU 12, for example, typically in conjunction with the storage/memory 14 and/or another non-transitory computer readable storage medium that stores the computer modules 20, runs the aforementioned programs or algorithms of FIGS. 3-6, as detailed below. The aforementioned programs or algorithms are, for example, represented in various forms including machine language/machine code for various types of processors, assembly for various types of processors, Java byte code, or in a programming language such as the “C” programming language, Java, JavaScript, Python, Go, C#, or other programming languages, as well as intermediate representations of the programming languages.

In the non-limiting exemplary embodiment illustrated in FIG. 1, the computer modules 20 include a source data retriever 22a, an information extractor 22b, an aggregator 22c, a user interface (UI) 22d, and a CRM system interface 22e.

With continued reference to FIG. 1, the system 10 is communicatively coupled to a CRM system 24, for example via the CRM system interface 22e. The CRM system 24 can, in certain embodiments, be part of the system 10. As is known in the art, CRM systems enable organizations to capture customer data by filling in various data fields or electronic forms in the CRM system pertaining to different aspects of customer data and the organization. The CRM system 24 can be any suitable CRM system, that can be any combination of software, hardware, and firmware, that supports customer relationship management functionality. The CRM system 24 can be implemented as any suitable CRM solution, such as, for example, CRM solutions provided by Salesforce of San Francisco California, HubSpot of Cambridge Massachusetts, Oracle of Santa Clara California, Zoho of Chennai India, SAP of Walldorf Germany, PeopleSoft of Pleasanton California, and Microsoft (Navision).

The CRM system interface 22e can be implemented, for example, as an application programming interface (API), network protocol, file system, or any other suitable means that supports communication between the system 10 and the CRM system 24, and in particular supports uploading of data and information from the system 10 to the CRM system 24. In the context of this document, uploading of data and information to a CRM system refers to filling of one or more data fields and/or electronic forms of the CRM system.

Although in the non-limiting example embodiments illustrated in the drawings the system 10 is communicatively coupled to a single CRM system 24, the system 10 according to embodiments of the present disclosure can be communicatively coupled to a plurality of CRM systems via corresponding interface arrangements. In some such embodiments, the coupling of the system 10 to each CRM system is provided by a corresponding CRM system interface 22e (such that the system 10 includes a plurality of CRM system interfaces 22e). In other embodiments, a single CRM system interface 22e may be used to couple the system 10 to the plurality of CRM systems. In further embodiments, one CRM system interface may provide coupling between the system 10 and one group of two or more CRM systems, another CRM system interface may provide coupling between the system 10 and another group of two or more CRM systems, and so on.

For case of presentation of the functions performed by the system 10 and its corresponding components, the system 10 will be described in the non-limiting context of being communicatively coupled to a single CRM system via the CRM system interface 22e.

The system 10, for example via the source data retriever 22a and/or the information extractor 22b, is communicatively coupled to at least one source of data 26. The source(s) of data 26 is/are representative of an interaction between two parties, namely a first party that is, has, or will be provided with services of an organization, and a second party that is a member of the organization. The first party is interchangeably referred to herein as a “customer” or “customer of the organization”, and the second party is interchangeably referred to herein as a “customer service representative”. Generally speaking, an interaction between the two parties includes at least one interaction event, where each interaction event is a conversation between the two parties. Without loss of generality, a conversation between the two parties can take various forms. For example, a conversation between a customer and a customer service representative can be an oral conversation that is conducted using telephonic or videoconferencing means, for example via the telephone (initiated, for example, by the customer dialing a customer service support telephone number, or the customer service representative dialing the customer's telephone number) or using a VoIP service or the like, or using a videoconferencing service such as Teams from Microsoft, Google Meet from Alphabet of Mountain View California, or Zoom from Zoom Video Communications of San Jose California. As another example, a conversation between a customer and a customer service representative can be a written conversation using a message exchange service such as email or instant messaging. For example, as an email exchange, a conversation between a customer and a customer service representative can be a series of emails between the customer and customer service representative under a common thread or subject, where each email contains a portion of the conversation. As an instant messaging exchange, a conversation between a customer and a customer service representative can be a series of text messages exchanged between the customer and the customer service representative using a text messaging service (e.g., WhatsApp, etc.) or a customer service support on-line chat provided by the organization. Without loss of generality, an interaction between a customer and a customer service representative may include a plurality of interaction events (i.e., a plurality of conversations). In such instances, some or all of the conversations may be of different respective forms. For example, one conversation of the interaction may be a telephone conversation between the customer and the customer service representative, another conversation of the interaction may be an email conversation between the customer and the customer service representative, and yet another conversation of the interaction may be a series of customer service chat messages between the customer and the customer service representative. Each interaction event of the interaction may be represented by a corresponding source of data. Accordingly, a plurality of sources of data can represent a corresponding plurality of interaction events of the same interaction. As a result, this set of sources of data are, as a whole, representative of the entire interaction.

In certain embodiments, the source(s) of data 26 is a source of linguistic data or textual data, for example a conversation of the interaction, a transcript of a conversation of the interaction, or a transcript of the entire interaction.

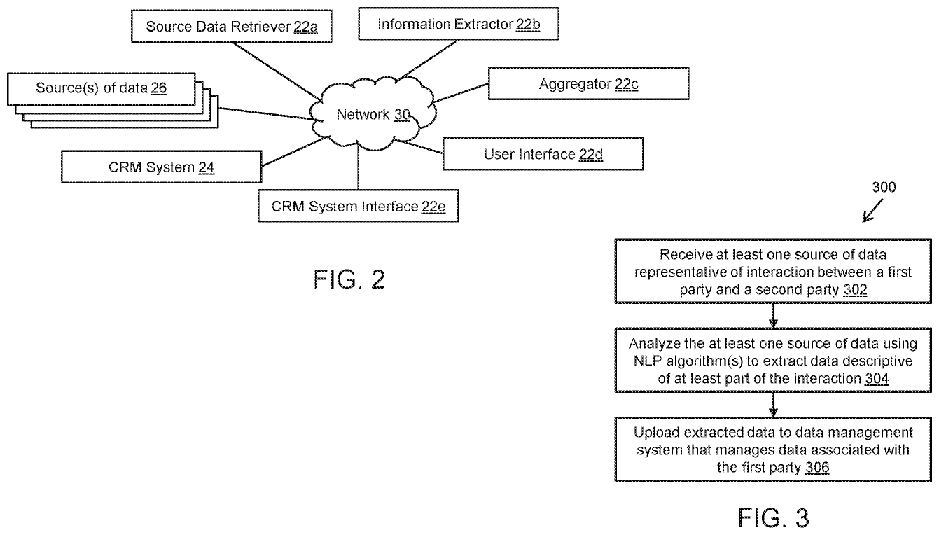

Parenthetically, it is noted that all of the components that are part of or used by the system 10 as illustrated in FIG. 1 are electronically or communicatively coupled (e.g., connected) to each other, either directly or indirectly. It is further noted that one or more of the modules 20 may be communicatively coupled to each other via a network. FIG. 2 illustrates an example environment in which a system according to an embodiment of the present disclosure can be deployed in a distributed manner, in which the source data retriever 22a, the information extractor 22b, the aggregator 22c, the UI 22d, and the CRM system interface 22e, as well as the CRM system 24 and the source(s) of data 26, are communicatively coupled to each other via a network 30, which may be formed of one or more communication networks, including for example, the Internet, cellular networks, wide area, public, and local networks.

With continued reference to FIGS. 1 and 2, in certain embodiments the source data retriever 22a functions to receive the source(s) of data 26. In certain embodiments, the source data retriever 22a retrieves the source(s) of data from a live source, such as a live conversation between the two parties, to enable real-time processing of the source(s) of data by the information extractor 22b. In other embodiments, for example when the source(s) of data is/are in the form of a recording(s) (audio or video) of a conversation(s), the source data retriever 22a retrieves the source(s) of data from a computer memory or other computer storage, to enable off-line processing of the data by the information extractor 22b.

In certain embodiments, the source data retriever 22a may further function to pre-process the source(s) of data 26 (either in real-time or off-line), for example by transcribing all or part of the interaction, represented by the source(s) of data 26, into text. For example, in embodiments in which the source(s) of data 26 are oral conversations, the source data retriever 22a may optionally execute transcribing functions to transcribe the oral conversation to text (i.e., a “transcript”). The source data retriever 22a can generate the transcript using any suitable means, for example using optical character recognition (OCR), and machine learning/artificial intelligence tools, such those provided by Otter.ai of Mountain View California, that transcribe audio and video to text.

In certain embodiments, the information extractor 22b may perform source(s) data retrieval, for example in embodiments in which the source(s) of data 26 is/are already in a format that more easily lends itself to natural language processing by the information extractor 22b, such as, for example, text format (i.e., a transcript). Thus, in certain embodiments in which the source(s) of data is/are a transcript of a conversation of the interaction or a transcript of the entire interaction, the information extractor 22b may perform retrieval the source(s) of data, for example from the message exchange service/application (e.g., email, chat, etc.).

The information extractor 22b further functions to extract information from the received source(s) of data 26. More specifically, the information extractor 22b functions to analyze the received source(s) of data 26 by executing one or more NLP algorithms to extract, from the source(s) of data 26, information that is descriptive of at least part of the interaction. The analysis/information extraction can be performed on the raw source(s) of data (for example when the source(s) of data are in the form of text-based data) or on pre-processed source(s) of data (for example on the text that is generated by the source data retriever 22a as a result of transcribing the source(s) of data).

In certain preferred embodiments, the extracted information includes at least one insight of the interaction, and in particular the extracted information includes insight data that is descriptive of at least one insight of the interaction. In the context of this document, an “insight” of an interaction generally refers to information within the interaction that can be deemed, for example by at least one of the customer or the customer service representative, to have particular value, meaning, or relevance to the interaction and/or the customer and/or the organization. The information extractor 22b extracts the insight information from the source(s) of data or parts of the source(s) of data, and can use, for example, pattern detection and exploitation to identify or generate insights, for example relatively-obvious patterns such as higher conceptual richness following a concept, or non-obvious and deeper patterns such as patterns identified by machine learning algorithms or other insight generation techniques.

The information extractor 22b can generate insights from the source(s) of data using any suitable natural language processing technique that implements suitable NLP algorithms, including algorithms that utilize one or more of: regression, pattern matching/detection using regular expressions, lexicons containing items of interest, ontologies, key phrase detection, n-gram detection, linguistic rules and patterns detection, cosine similarity and/or Euclidean similarity, TF-IDF, vector space representation of words such as Word2Vec, Doc2Vec, Doc2Doc, foundational models and/or large language models (such as GPT), zero-shot and few-shot models, information extraction tools such as question-answering models, heuristics and domain-knowledge heuristics in particular, and automated machine learning. In addition, the information extractor 22b may generate insights from other conversations and/or interactions and other data sources, and may also generate insights based on user (customer service representative) input, such as a user marking of parts of a transcript.

For example, the insights can be insights in a predetermined set of categories, such as questions and answers on topics in predefined talking points of interest, indication that such questions or answers have been provided by a participant in the conversation (i.e., by the customer or the customer service representative), or any other insight generated by NLP algorithm(s), user input, or any combination thereof. Another example are insights relating to question answering and information providing. When a participant in the conversation asks a question, makes a statement, or performs any other action that merits providing additional information, information deemed relevant to that question or statement, whether generated in the current conversation, generated in other conversations, or generated from any other source, is presented to the user (the customer service representative). Such relevant information can be previous answers to questions, relevant facts, tips, or any other information or insight.

According to certain embodiments, the insight data that is generated by the information extractor 22b may be descriptive of multiple insights extracted from the interaction, where each insight may be associated with a different respective aspect (i.e., a different conversation) of the interaction. Furthermore, each source of data may correspond to a different aspect of the interaction. The insight data that is generated by the information extractor 22b may include multiple sets of data elements, where each set of data elements is descriptive of a different respective one of the insights.

In certain embodiments, the information extractor 22b performs additional functions, including, for example, classification of data/information and arrangement of data/information. The classification can include classifying of the extracted information (e.g., insight data) into one or more categories, as well as classifying the source(s) of data or one or more sub-sections of the source(s) of data into one or more categories. For example, the information extractor 22b may analyze the source(s) of data by parsing a transcript (or transcripts) of the interaction into one or more transcript sections, and then optionally classifying the one or more transcript sections according to a plurality of classification labels. In certain embodiments, the classification labels may be set automatically by the system 10. In other embodiments, the user (customer service representative or an administrator of the system 10), may manually set the classification labels using, for example, the UI 22d (which may be a graphical user interface). In yet other embodiments, the classification labels may be automatically set by the system 10 and provided to the user for approval (for example via the UI 22d), allowing the user to edit (modify) the set labels should the user so choose. The modification of automatically set labels, may be performed by the user using, for example, the UI 22d.

The arrangement of data/information that can be performed by the information extractor 22b can, in certain embodiments, include arranging the extracted information that can be presented to the user (customer service representative) in a manner that is organized and easy to understand from the point of view of the customer service representative. Arrangement functions can also include summarizing the extracted information, e.g., summarizing the extracted insight data. Arrangement functions can also include arranging or summarizing other data derived from the source(s) of data, including arranging or summarizing the classified data or the source(s) of data itself.

In certain embodiments, the information extractor 22b may also function to pre-process the source(s) of data, for example by transcribing the interaction, represented by the source(s) of data 26, into text.

The aggregator 22c functions to aggregate data, which can then be presented to the user, for example through the UI 22d. The data that can be aggregated by the aggregator 22c includes, for example, the source(s) of data and the information/data (e.g., insight data) extracted by the information extractor 22b. The aggregator 22c can aggregate data collected/processed over a period of time, for example the information extracted by the information extractor 22b from source(s) of data over a one-day period, such that the aggregated data is presented to the user in a combined fashion as a summary, for example at the end of the work day. Here too the aggregated data can be presented to the user for editing and approval, for example immediately after the conclusion of the interaction or conversation of the interaction, or at any other time, such as at the end of the day.

According to certain embodiments, the aggregator 22c may aggregate sets of data elements of the insight data that is generated by the information extractor 22b to produce an aggregated data element that is a representation of an aggregation of some or all of the generated insights.

The UI 22d, in addition to providing a means for the system 10 to present data/information to the customer service representative, and also provides the customer service representative with means for interacting with the system 10, including providing feedback to the system 10 and some of its computer components (modules 20). For example, the customer service representative can flag certain parts of an interaction as items of interest, for example by marking parts of the interaction according to conversation timestamps, and the information extractor 22b can analyze the flagged parts of the interaction. As another example, the customer service representative may utilize the UI 22d to instruct the information extractor 22b to classify the source(s) of data into categories (which can be set, for example, by the customer service representative).

As mentioned above, the CRM system interface 22e supports uploading of data and information from the system 10 to the CRM system 24. In more particular terms, the CRM system interface 22e enables the system 10 to fill relevant data fields and/or electronic forms of the CRM system 24 with data/information derived from the information extracted by the information extractor 22b. In certain embodiments, this data/information is the raw insight data generated by the information extractor 22b. In other embodiments, this data/information is post-processed insight data, for example, classified insight data, aggregated insight data, arranged insight data, etc. In yet further embodiments, the data/information filled in the data fields of the CRM system 24 is the aforementioned types of data/information in combination with one or more of the source(s) of data.

In certain embodiments, the data fields and/or electronic forms of the CRM system 24 are automatically filled by the system 10 with the aforementioned data/information. In other embodiments, the aforementioned data/information is provided to the user for viewing and/or editing and/or approval (via the UI 22d) prior to being uploaded to the CRM system 24.

It is noted that although the embodiments of the present disclosure described above have primarily referred to insight data, or derivatives thereof, as the data/information that is uploaded to the CRM system 24, the data/information that can be uploaded to the CRM system 24 according to embodiments of the present disclosure is not limited to insight-type data. In general, the data fields of the CRM system 24 can be filled with any data derived from the source(s) of data 26, such as any data that is based on a transcript of a conversation, conversation data (not necessarily a transcript) or phonetic data, as well as NLP-generated insight data that is derived from any suitable type of data source (e.g., transcript, conversation data, phonetic data, etc.).

As mentioned above, the computer modules 20 are stored in a non-transitory computer readable storage medium electronically coupled to the CPU 12, such that the machine executable instructions stored in the computer modules 20 can be loaded and executed by the CPU 12. The subdivision of the machine executable instructions that are stored in the computer modules 20 (e.g., the source data retriever 22a, the information extractor 22b, and the aggregator 22c) has been described and illustrated herein according to a functional subdivision. It should be noted, however, that the machine executable instructions may be stored in the computer modules 20 according to any suitable or desired subdivision. For example, in certain embodiments, the information extractor 22b may store machine executable instructions to perform all of the functions of the source data retriever 22a, the information extractor 22b, and the aggregator 22c described above, rendering the source data retriever 22a and the aggregator 22c redundant.

Attention is now directed to FIG. 3 which shows a flow diagram illustrating a computer-implemented (i.e., a computerized) process (i.e., method) 300 in accordance with embodiments of the disclosed subject matter. This computer-implemented process 300 includes steps for automatically or semi-automatically inserting information, including NLP insights, extracted from interactions between two parties, into data management systems that are managed by organizations to which one of the two parties belongs. Reference is also made to FIGS. 1 and 2 and the components illustrated therein. The process and sub-processes of FIG. 3 are computerized processes performed by the system 10, including, for example, the CPU 12 and associated components, such as the source data retriever 22a, the information extractor 22b, the aggregator 22c, the UI 22d, and the CRM system interface 22e.

The process 300 begins at step 302, where the system 10 (for example using the source data retriever 22a and/or the information extractor 22b) receives at least one source of data that is representative of an interaction between a first party (e.g., a customer of an organization) and a second party (e.g., a customer service representative that is part of the organization). As mentioned above, in certain embodiments the source data retriever 22a and/or the information extractor 22b may process the at least one source of data by transcribing the at least one source of data into text.

At step 304, the system 10 (for example using the information extractor 22b) analyzes the at least one source of data using NLP algorithm(s) to extract, from the at least one source of data, data/information that is descriptive of at least part of the interaction, for example one or more parts of one or more conversations of the interaction. As discussed above, the data/information that is descriptive of at least part of the interaction can include insight data, but may also include aggregated data, classified source data, or other data derived from the at least one source of data by natural language processing, i.e., execution of NLP algorithm(s).

At step 306, the system 10 (for example via the CRM system interface 22e) uploads data/information derived from the extracted information to a data management system (e.g., a CRM system 24) that manages data associated with the first party. For example, at step 306 the data field(s) and/or electronic forms of the CRM system 24 can be filled with data or information derived from the information extracted at step 304. The derived data or information can be, for example insight data or information, aggregated insight data, user edited data or information, etc. In certain embodiments, step 306 may be executed automatically by the system 10. In other embodiments, step 306 may be executed in response to approval or confirmation of the upload by the customer service representative (for example via the UI 22d). The upload of the data/information derived from the extracted information may occur at the conclusion of a portion of the interaction (i.e., at the conclusion of a conversation of the interaction) or at the conclusion of the entire interaction.

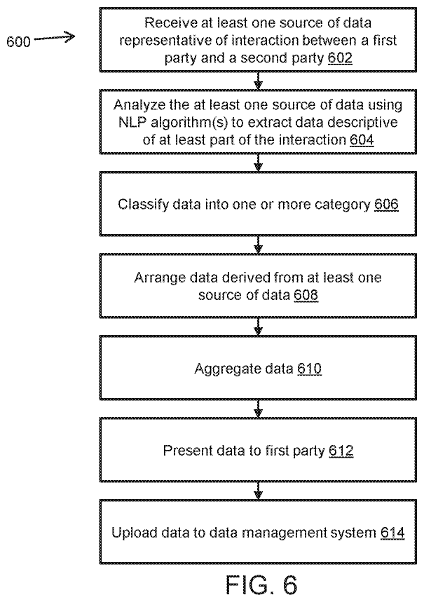

In certain embodiments, after the execution of step 304, the system 10 may present some or all of the extracted information to the customer service representative (via the UI 22d), and the customer service representative may edit or approve the presented data before the process 300 moves to step 306. FIGS. 5 and 6 show flow diagrams according to such embodiments.

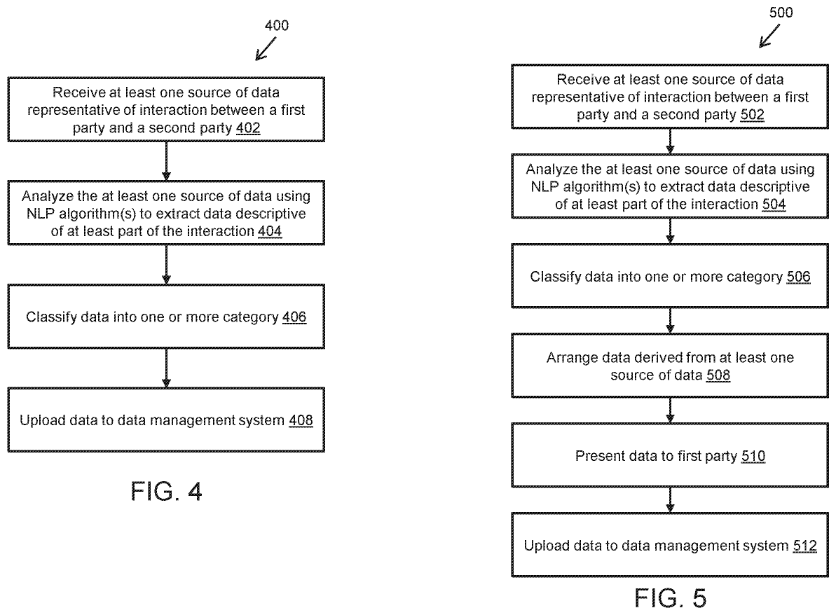

Attention is now directed to FIG. 4 which shows a flow diagram illustrating a computer-implemented (i.e., a computerized) process (i.e., method) 400 in accordance with embodiments of the disclosed subject matter. This computer-implemented process 400 is generally similar to the process 300, but includes additional processing steps.

The process 400 begins at step 402, which is generally similar to step 302. The process 400 then moves to step 404, which is generally similar to step 304. The process 400 may then execute step 406, where the system 10 (for example using the information extractor 22b) performs classification of data into one or more categories, including, for example, classification of the information extracted at step 404 and/or classifying the at least one source of data or one or more sub-sections of the at least one source of data into one or more categories. It is noted that in embodiments in which step 406 is performed to only classify the at least one source of data, steps 404 and 406 can be executed in parallel (i.e., contemporaneously) or step 406 can be executed before step 404.

Next, at step 408, the system 10 (for example via the CRM system interface 22e) uploads data/information derived the data generated at step 404 and/or step 406 to a data management system (e.g., a CRM system 24) that manages data associated with the first party. Step 408 is generally similar to step 306, with the additional option of uploading the data categorically classified at step 406 (or derivatives thereof).

Attention is now directed to FIG. 5 which shows a flow diagram illustrating a computer-implemented (i.e., a computerized) process (i.e., method) 500 in accordance with embodiments of the disclosed subject matter. This computer-implemented process 500 is generally similar to the processes 300 and 400, but includes additional processing steps.

The process 500 executes steps 502, 504, and 506, which are generally similar to steps 402, 404, and 406, respectively. The process 500 may then execute step 508, where the system 10 (for example using the information extractor 22b) arranges data derived from the at least one source of data. This can include arranging or summarizing the data/information extracted at step 504, the categorically classified data at step 506, the at least one source of data itself, or any combination thereof.

Next, at step 510, data derived from the at least one source of data is presented to the user (i.e., the first party, the customer service representative). This presented data can be the information extracted at step 504, the categorically classified data at step 506, the arranged data at step 508, the at least one source of data itself, or any combination thereof. The user may then provide feedback to the system 10 by, for example editing part of the data presented at step 510. The edited data may then be uploaded to a data management system at step 512 (similar to as in steps 306 and 408). In some embodiments, the upload is automatic, whereas in other embodiments the upload is only performed in response to an approval of the data by the user.

Attention is now directed to FIG. 6 which shows a flow diagram illustrating a computer-implemented (i.e., a computerized) process (i.e., method) 600 in accordance with embodiments of the disclosed subject matter. This computer-implemented process 600 is generally similar to the processes 300, 400, and 500, but includes additional processing steps.

The process 600 executes steps 602, 604, 606, and 608, which are generally similar to steps 502, 504, 506, and 508, respectively. The process 600 may then execute step 610, where the system 10 (for example using the aggregator 22c) aggregates data derived from the at least one source of data. This aggregation can include, for example, aggregating the data/information extracted at step 604 (i.e., aggregating information extracted from different sources of data), the categorically classified data at step 606, the data arranged at step 608, the at least one source of data itself, or any combination thereof.

Next, at step 612, the aggregated data is presented to the user, similar to as in step 508. The user may then provide feedback to the system 10 by, for example editing part of the data presented at step 612. The edited data may then be uploaded to a data management system at step 614 (similar to as in steps 306, 408, and 512).

Although the embodiments described thus far have pertained to a system 10 that is communicatively coupled to one or more CRM systems via a CRM interface arrangement (i.e., one or more CRM system interfaces 22e), in certain embodiments, the system 10 can be integrated with the CRM system(s) such that the CRM system(s), in addition to performing functions of conventional CRM systems, can perform functions of the system 10 as described herein. Accordingly, certain embodiments of the present disclosure provide a CRM system having, in addition to the components that are germane to conventional CRM systems, components of the system 10, in particular the modules 20, and more specifically the source data retriever 22a, the information extractor 22b, and the aggregator 22c.

Implementation of the method and/or system of embodiments of the disclosure can involve performing or completing selected tasks manually, automatically, or a combination thereof. Moreover, according to actual instrumentation and equipment of embodiments of the method and/or system of the disclosure, several selected tasks could be implemented by hardware, by software or by firmware or by a combination thereof using an operating system.

For example, hardware for performing selected tasks according to embodiments of the disclosure could be implemented as a chip or a circuit. As software, selected tasks according to embodiments of the disclosure could be implemented as a plurality of software instructions being executed by a computer using any suitable operating system. In an exemplary embodiment of the disclosure, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, non-transitory storage media such as a magnetic hard-disk and/or removable media, for storing instructions and/or data. Optionally, a network connection is provided as well. A display and/or a user input device such as a keyboard or mouse are optionally provided as well.

For example, any combination of one or more non-transitory computer readable (storage) medium(s) may be utilized in accordance with the above-listed embodiments of the present disclosure. A non-transitory computer readable (storage) medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

As will be understood with reference to the paragraphs and the referenced drawings, provided above, various embodiments of computer-implemented methods are provided herein, some of which can be performed by various embodiments of apparatuses and systems described herein and some of which can be performed according to instructions stored in non-transitory computer-readable storage media described herein. Still, some embodiments of computer-implemented methods provided herein can be performed by other apparatuses or systems and can be performed according to instructions stored in computer-readable storage media other than that described herein, as will become apparent to those having skill in the art with reference to the embodiments described herein. Any reference to systems and computer-readable storage media with respect to the following computer-implemented methods is provided for explanatory purposes, and is not intended to limit any of such systems and any of such non-transitory computer-readable storage media with regard to embodiments of computer-implemented methods described above. Likewise, any reference to the following computer-implemented methods with respect to systems and computer-readable storage media is provided for explanatory purposes, and is not intended to limit any of such computer-implemented methods disclosed herein.

The flowcharts and block diagrams in the accompanying drawings illustrate the architecture, functionality, and operation of possible implementations of systems, methods and computer program products according to various embodiments of the present disclosure. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

The above-described processes including portions thereof can be performed by software, hardware and combinations thereof. These processes and portions thereof can be performed by computers, computer-type devices, workstations, processors, micro-processors, other electronic searching tools and memory and other non-transitory storage-type devices associated therewith. The processes and portions thereof can also be embodied in programmable non-transitory storage media, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the singular form, “a”, “an” and “the” include plural references unless the context clearly dictates otherwise.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable subcombination or as suitable in any other described embodiment of the disclosure. Certain features described in the context of various embodiments are not to be considered essential features of those embodiments, unless the embodiment is inoperative without those elements.

To the extent that the appended claims have been drafted without multiple dependencies, this has been done only to accommodate formal requirements in jurisdictions which do not allow such multiple dependencies. It should be noted that all possible combinations of features which would be implied by rendering the claims multiply dependent are explicitly envisaged and should be considered part of the disclosure.

Although the disclosure has been described in conjunction with specific embodiments thereof, it is evident that many alternatives, modifications, and variations will be apparent to those skilled in the art. Accordingly, it is intended to embrace all such alternatives, modifications and variations that fall within the spirit and broad scope of the appended claims.

What is claimed is:

1. A method comprising:
analyzing, using one or more natural language processing algorithms, at least one source of data that is representative of an interaction between a first party and a second party to extract from the at least one source of data, information that is descriptive of at least part of the interaction; and
uploading information derived from the extracted information to a data management system that manages data associated with the first party.

2. The method of claim 1, wherein the at least one source of data includes at least one of linguistic data or textual data.

3. The method of claim 1, wherein the at least one source of data is a transcript of at least part of the interaction.

4. The method of claim 1, wherein the analyzing the at least one source of data includes transcribing the at least one source of data into text to produce a transcript of at least part of the interaction.

5. The method of claim 4, wherein the analyzing the at least one source of data further includes parsing the transcript into one or more transcript sections.

6. The method of claim 5, wherein the analyzing the at least one source of data further includes classifying the one or more transcript sections according to a plurality of classification labels.

7. The method of claim 1, wherein the at least one source of data is received from a computer memory.

8. The method of claim 1, wherein the information derived from the extracted information includes at least one insight of the interaction.

9. The method of claim 1, further comprising: modifying, by the second party, the extracted information to produce the information derived from the extracted information, prior to the information derived from the extracted information being uploaded to the system.

10. A method comprising:
analyzing, using one or more natural language processing algorithms, at least one source of data that is representative of an interaction between a customer and a customer service representative to extract from the at least one source of data insight data that is descriptive of at least one insight of the interaction; and
uploading the insight data to a customer relationship management system that manages data associated with the customer and that is managed by an organization that includes the customer service representative.

11. The method of claim 10, wherein the at least one source of data includes at least one of linguistic data or textual data.

12. The method of claim 10, wherein the at least one source of data is a transcript of the interaction.

13. The method of claim 10, wherein the analyzing the at least one source of data includes transcribing the at least one source of data into text.

14. The method of claim 10, wherein each insight of the at least one insight is an insight in a category from a set of predetermined categories.

15. The method of claim 14, wherein the set of predetermined categories includes: questions and answers on topics in predefined conversation points of interest of the interaction, and indications that questions or answers were provided by the customer or the customer service representative.

16. The method of claim 10, further comprising: modifying, by the customer service representative, the insight data prior to the insight data being uploaded to the customer relationship management system.

17. The method of claim 10, wherein the at least one source of data includes a plurality of sources of data, each source of data corresponding to a different respective aspect of the interaction, and wherein the insight data includes a plurality of sets of data elements, each set of data elements being descriptive of a respective insight of a plurality of insights, each insight of the plurality of insights being associated with a different respective one of the aspects, the method further comprising: aggregating the data elements to produce an aggregated data element that is a representation of an aggregation of the plurality of insights.

18. A method comprising:
analyzing, using one or more natural language processing algorithms, at least one source of data that is representative of an interaction between a customer of an organization and a customer service representative that is a member of the organization to extract from the at least one source of data information that is descriptive of at least part of the interaction; and
uploading information derived from the extracted information to a customer relationship management system that manages data associated with the customer and that is managed by the organization.
